(19) United States
(12) Patent Application Publication
(10) Pub. No.: US 2022/0043613 A1
(43) Pub. Date: Feb. 10, 2022

(54) PRINT JOB TRANSMISSION DEVICE AND COMPUTER READABLE NON-TRANSITORY RECORDING MEDIUM STORING A PRINT JOB TRANSMISSION PROGRAM

(71) Applicant: KYOCERA Document Solutions Inc., Osaka-shi (JP)

(72) Inventors: Kazuki DOZEN, Osaka-shi (JP); Takanori MIYAMOTO, Osaka-shi (JP)

(21) Appl. No.: 17/387,104

(22) Filed: Jul. 28, 2021

(30) Foreign Application Priority Data
Aug. 4, 2020 (JP) 2020-132472

(51) Int. Cl. G06F 3/12

(52) U.S. Cl. CPC G06F 3/1207; G06F 3/1288; G06F 3/1259

(57) ABSTRACT

A print job transmission device includes a print job transmitter to transmit a print job to an image forming apparatus, an information acquirer to acquire information from the image forming apparatus. The information acquirer acquires information on ink from the image forming apparatus when an event that has occurred in the image forming apparatus is notified by the image forming apparatus.

### INCORPORATION BY REFERENCE

This application is based upon, and claims the benefit of priority from, corresponding Japanese Patent Application No. 2020-132472 filed in the Japan Patent Office on Aug. 4, 2020, the entire contents of which are incorporated herein by reference.

### BACKGROUND

### Field of the Invention

The present disclosure relates to a print job transmission device that transmits a print job and a computer-readable non-transitory recording medium storing a print job transmission program.

### Description of Related Art

Typically, an image forming system is known that has an image forming apparatus that performs printing and a print job transmission device that transmits a print job to the image forming apparatus. When an error occurs, this image forming apparatus notifies the print job transmission device of the error.

### SUMMARY

The print job transmission device of the present disclosure includes a print job transmitter to transmit a print job to an image forming apparatus, an information acquirer to acquire information from the image forming apparatus. The information acquirer acquires specific information from the image forming apparatus when an event that has occurred in the image forming apparatus is notified by the image forming apparatus.

The computer-readable non-transitory recording medium of the present disclosure stores a print job transmission program. The print job transmission program causes a computer to implement a print job transmitter to transmit a print job to an image forming apparatus, and an information acquirer to acquire information from the image forming apparatus. The information acquirer acquires specific information from the image forming apparatus when an event that has occurred in the image forming apparatus is notified by the image forming apparatus.

### BRIEF DESCRIPTION OF THE DRAWINGS

FIG. 1 is a block diagram of an image forming system according to one embodiment of the present disclosure;

FIG. 2 is a block diagram of an image forming apparatus illustrated in FIG. 1;

FIG. 3 is a block diagram of a print job transmission device illustrated in FIG. 1;

FIG. 4 is a sequence diagram of an operation of the image forming system illustrated in FIG. 1 when the print job transmission device connects to the image forming apparatus;

FIG. 5 is a sequence diagram of an operation of the image forming system illustrated in FIG. 1 when an event occurs in the image forming apparatus;

FIG. 6 is a diagram illustrating an example of a device information notification screen that notifies at least some of the device information illustrated in FIG. 3;

FIG. 7 is a sequence diagram of an example of the operation of the image forming system when an event occurs in the image forming apparatus, which is different from the example illustrated in FIG. 5; and

FIG. 8 is a sequence diagram of an example of the operation of the image forming system when an event occurs in the image forming apparatus, which is different from the examples illustrated in FIGS. 5 and 7.

### DETAILED DESCRIPTION

The following describes an embodiment of the present disclosure with the use of the accompanying drawings.

First, an image forming system according to one embodiment of the disclosure will be described.

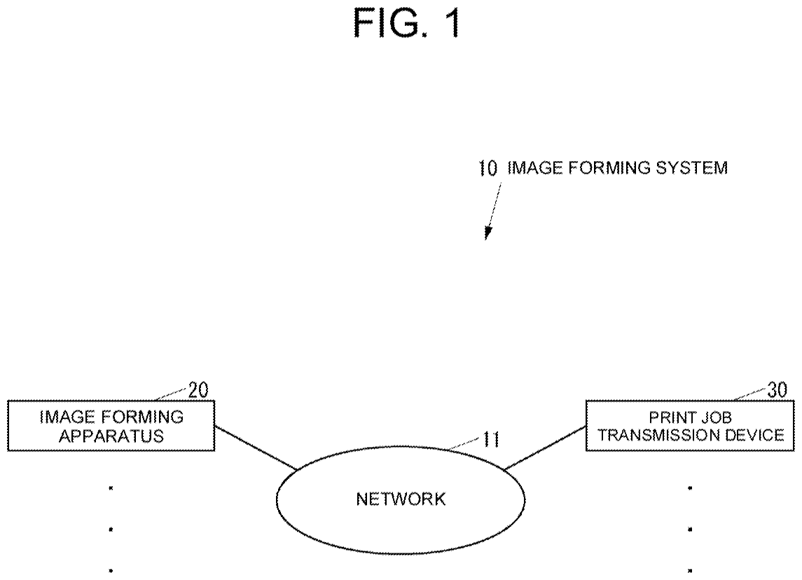

FIG. 1 is a block diagram of an image forming system 10 according to the present embodiment.

As illustrated in FIG. 1, the image forming system 10 includes an image forming apparatus 20 to execute printing. The image forming system 10 can include at least one image forming apparatus having a similar configuration as that of the image forming apparatus 20, other than the image forming apparatus 20. The image forming apparatus includes, for example, an MFP (Multifunction Peripheral), a production printer, and the like.

The image forming system 10 includes a print job transmission device 30 as a computer to transmit a print job to the image forming apparatus 20. The image forming system 10 can include at least one print job transmission device having a similar configuration as that of the print job transmission device 30, other than the print job transmission device 30. The print job transmission device 30 includes, for example, a personal computer (PC).

The image forming apparatus in the image forming system 10 and the print job transmission device in the image forming system 10 can communicate to each other, for example, via a network 11 such as a local area network (LAN) or the Internet.

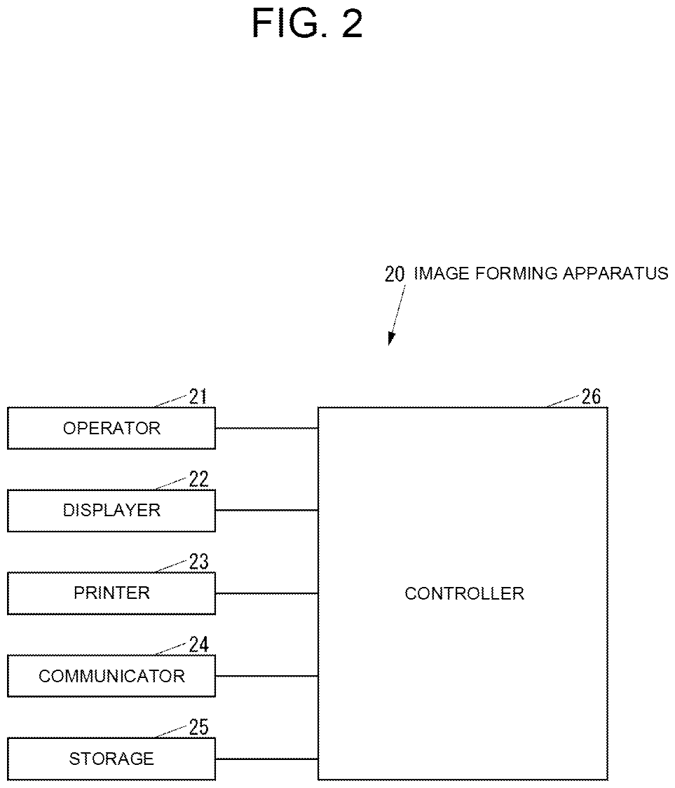

FIG. 2 is a block diagram of the image forming apparatus 20.

As illustrated in FIG. 2, the image forming apparatus 20 includes an operator 21 that is an operation device such as a button with which various operations are input, a displayer 22 that is a display device such as a liquid crystal display (LCD) to display various information, a printer 23 that is a printing device to print an image on a recording medium such as a paper, a communicator 24 that is a communication device to communicate directly with external devices via a network such as a LAN or the Internet or by wire or wirelessly without the network, a storage 25 that is a non-volatile storage device such as a semiconductor memory or a hard disk drive (HDD) to store various pieces of information, and a controller 26 to control the entire image forming apparatus 20.

The controller 26 includes, for example, a CPU (Central Processing Unit), a ROM (Read Only Memory) that stores programs and various kinds of data, and a RAM (Random Access Memory) as a memory used for the work area of the CPU of the controller 26. The CPU of the controller 26 executes the program stored in the storage 25 or the ROM of the controller 26.

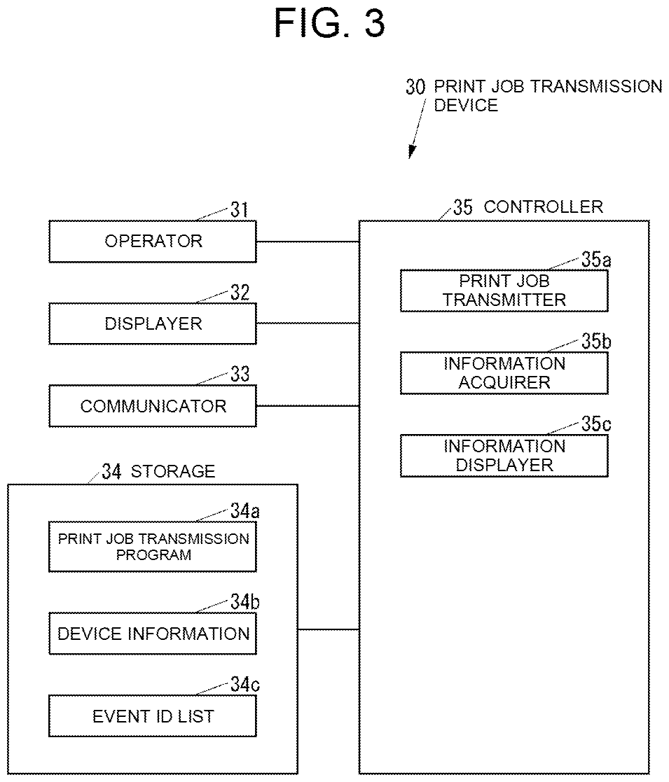

FIG. 3 is a block diagram of the print job transmission device 30.

As illustrated in FIG. 3, the print job transmission device 30 includes an operator 31 that is an operation device such as a keyboard and a mouse with which various operations are input, a displayer 32 that is a display device such as an LCD to display various information, a communicator 33 that is a communication device to communicate directly with external devices via a network such as a LAN or the Internet or by wire or wirelessly without the network, a storage 34 that is a non-volatile storage device such as a semiconductor memory or a hard disk drive (HDD) to store various pieces of information, and a controller 35 to control the entire print job transmission device 30.

The storage 34 stores a print job transmission program 34a for transmitting a print job. The print job transmission program 34a may be installed in the print job transmission devices 30, for example, at the manufacturing stage of the print job transmission device 30, may be additionally installed in the print job transmission device 30 from an external storage medium such as a compact disk (CD), a digital versatile disk (DVD), or a USB (Universal Serial Bus) memory, or may be additionally installed in the print job transmission device 30 from a network.

The storage 34 is capable of storing device information 34b that indicates various pieces of information in the image forming apparatus 20. The device information 34b includes, for example, information on the ink in the image forming apparatus 20 and information on the recording medium in the image forming apparatus 20. The information on the ink in the image forming apparatus 20 includes, for example, the remaining amount of the ink in the image forming apparatus 20 and information on the availability of the ink in the image forming apparatus 20, for example, for each type of ink such as cyan, magenta, yellow, and black. The information on the availability of the ink in the image forming apparatus 20 is, for example, information indicating that the use of the ink is not possible when the ink cassette is not set in the image forming apparatus 20. The information on the recording medium in the image forming apparatus 20 may include, for example, the remaining amount of the recording media in a supply tray for supplying the recording medium to the printer 23 for each supply tray, or the amount of the recording medium in the destination of the recording medium from the printer 23 for each destination.

The storage 34 stores an event ID list 34c which is a list of event IDs for identifying the types of events that occur in the image forming apparatus 20. As for the types of the events, for example, there are Cyan Empty that indicates that the amount of cyan ink remaining is less than or equal to a certain amount, Magenta Empty that indicates that the amount of magenta ink remaining is less than or equal to a certain amount, Yellow Empty that indicates that the amount of yellow ink remaining is less than or equal to a certain amount, Black Empty that indicates that the amount of black ink remaining is less than or equal to a certain amount, Cyan Missing that indicates that the cyan ink cassette is not set in the image forming apparatus 20, Magenta Missing that indicates that the magenta ink cassette is not set in the image forming apparatus 20, Yellow Missing that indicates that the yellow ink cassette is not set in the image forming apparatus 20, Black Missing that indicates that the black ink cassette is not set in the image forming apparatus 20, and Waste Ink Box Full that indicates that the amount of waste ink in the waste ink box in the image forming apparatus 20 is equal to or greater than a certain amount. In the event ID list 34c, the event ID of an ink-related event is associated with information indicating that the event is an ink-related event. For example, Cyan Empty, Magenta Empty, Yellow Empty, Black Empty, Cyan Missing, Magenta Missing, Yellow Missing, Black Missing, and Waste Ink Box Full are ink-related events.

The controller 35 includes, for example, a CPU, a ROM storing a program and various data, and a RAM as a memory applied as a workspace of the CPU of the controller 35. The CPU of the controller 35 executes the program stored in the storage 34 or the ROM of the controller 35.

By executing the print job transmission program 34a, the controller 35 implements a print job transmitter 35a that transmits a print job to the image forming apparatus 20, an information acquirer 35b that acquires information from the image forming apparatus 20, and an information displayer 35c that displays the information.

Next, the operation of the image forming system 10 will be described.

First, the operation of the image forming system 10 when the print job transmission device 30 connects to the image forming apparatus 20 will be described.

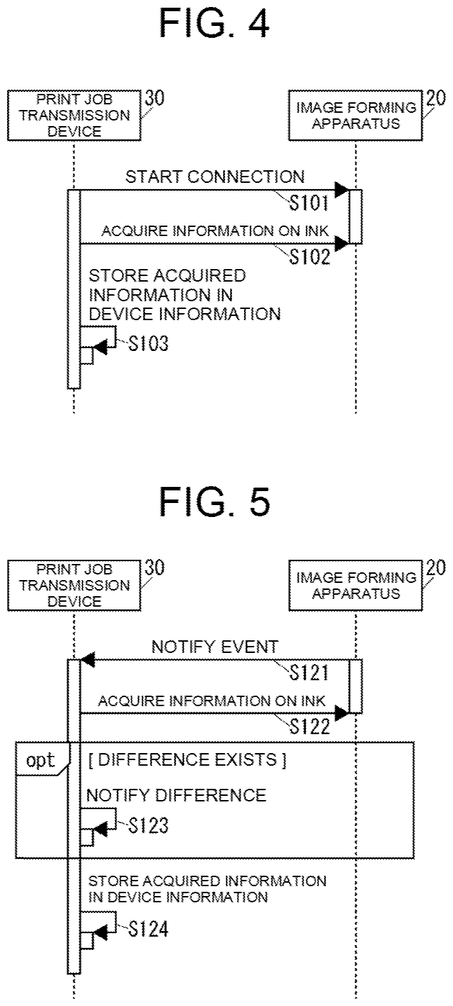

FIG. 4 is a sequence diagram of an operation of the image forming system 10 when the print job transmission device 30 connects to the image forming apparatus 20.

With the print job transmission program 34a being running, a user of the print job transmission device 30 can instruct the print job transmission device 30 from the operator 31 to start a connection with the image forming apparatus 20. When instructed to start a connection with the image forming apparatus 20, the print job transmitter 35a of the print job transmission device 30 performs the operation illustrated in FIG. 4.

As illustrated in FIG. 4, the print job transmitter 35a starts a connection with the image forming apparatus 20 (S101). Accordingly, the print job transmitter 35a can transmit a print job to the image forming apparatus 20 until the connection with the image forming apparatus 20 is terminated.

After the processing of S101, the information acquirer 35b of the print job transmission device 30 acquires information on the ink in the image forming apparatus 20 from the image forming apparatus 20 (S102). The information acquirer 35b acquires, in S102, a value of an item of the information on the ink included in the device information 34b as information on the ink in the image forming apparatus 20. For example, the information acquirer 35b acquires the remaining amount of the ink in the image forming apparatus 20 and the information on the availability of the ink in the image forming apparatus 20 for each type of ink.

After the processing of S102, the information acquirer 35b stores the information acquired in S102 in the device information 34b (S103).

Next, the operation of the image forming system 10 when an event occurs in the image forming apparatus 20 will be described.

FIG. 5 is a sequence diagram of the operation of the image forming system 10 when an event occurs in the image forming apparatus 20.

The controller 26 of the image forming apparatus 20 performs the operation illustrated in FIG. 5 when an event occurs in the image forming apparatus 20.

As illustrated in FIG. 5, the controller 26 of the image forming apparatus 20 notifies the print job transmission program 34a of the print job transmission device 30 of an event that has occurred in the image forming apparatus 20 (S121). The notification in S121 includes an event ID to identify the type of event and an event importance level to indicate the importance of the event. As for the event importance level, for example, there are an error indicating that the image forming apparatus 20 is unable to perform printing and information indicating the progress of the execution of printing in the image forming apparatus 20.

Upon receiving the notification in S121, the information acquirer 35b of the print job transmission device 30 acquires the information on the ink in the image forming apparatus 20 from the image forming apparatus 20 (S122).

After the processing of S122, when there is a difference between the information acquired in S122 and the information included in the device information 34b with respect to the value of any item of the information acquired in S122, the information displayer 35c of the print job transmission device 30 notifies this difference by the display by the displayer 32 (S123). For example, with regard to the item of the availability of cyan ink in the image forming apparatus 20, when the information included in the device information 34b is “available” and the information acquired in S122 is “unavailable”, the information displayer 35c notifies, by the displayer 32, that the cyan ink in the image forming apparatus 20 cannot be used.

When there is no difference between the information acquired in S122 and the information contained in the device information 34b with regard to the values of all items of the information acquired in S122, or when the processing of S123 is completed, the information acquirer 35b of the print job transmission device 30 overwrites each of the items of the information acquired in S122 with the information acquired in S122, and saves the overwritten information in the device information 34b (S124).

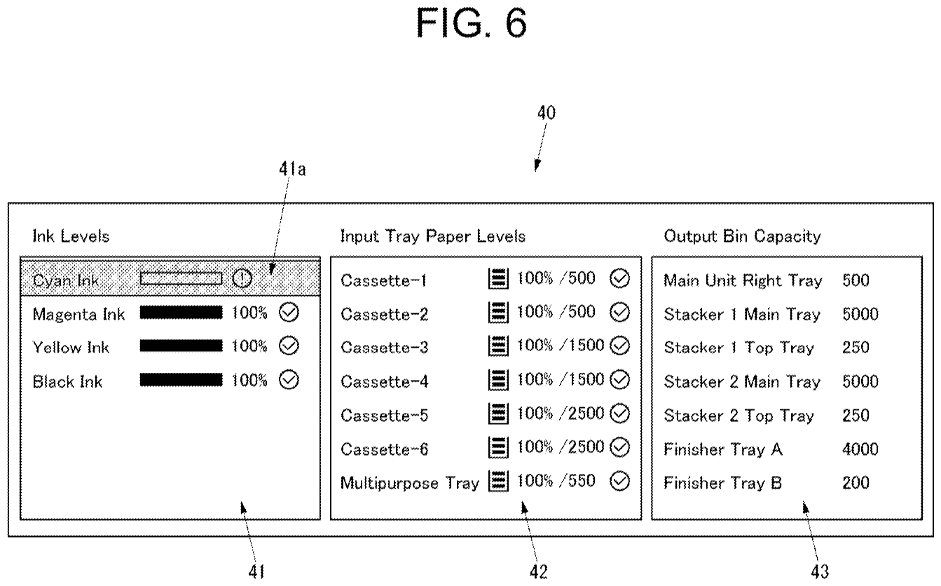

FIG. 6 is a diagram illustrating an example of a device information notification screen 40 that notifies at least some of the device information 34b.

The information displayer 35c of the print job transmission device 30 displays, for example, the device information notification screen 40 illustrated in FIG. 6 on the displayer 32. The device information notification screen 40 illustrated in FIG. 6 includes an ink level display area 41 in which the ink level is displayed for each ink cassette, a recording medium level display area 42 in which the level of recording medium in the supply tray for supplying the recording medium to the printer 23 is displayed for each supply tray, and a recording medium storage amount display area 43 that displays the amount of the recording medium at the discharge destination of the recording medium from the printer 23 for each discharge destination. In the device information notification screen 40 illustrated in FIG. 6, an indication 41a is included in the ink level display area 41 to indicate that the cassette of cyan ink is not set in the image forming apparatus 20. The indication 41a was generated in S123.

As described above, the print job transmission device 30 acquires information on ink from the image forming apparatus 20 (S122) when an event that has occurred in the image forming apparatus 20 is notified by the image forming apparatus 20 in S121. Thus, the possibility of acquiring information from the image forming apparatus 20, that is less necessary for the print job transmission device 30 side, can be reduced. As a result, the load on the image forming system 10 for acquiring information from the image forming apparatus 20 can be reduced. Here, the load on the image forming system 10 includes, for example, the load on the network 11, the load on the image forming apparatus 20, and the load on the print job transmission device 30.

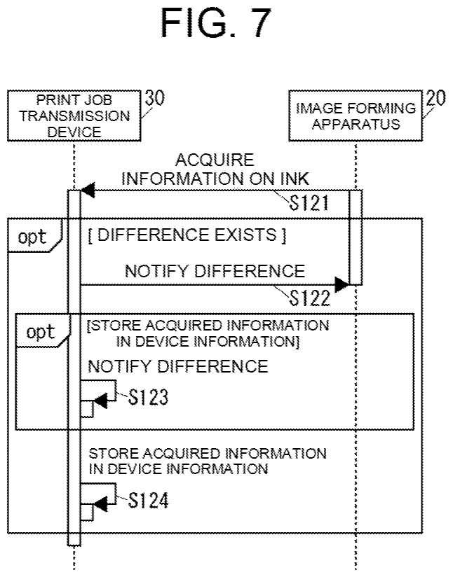

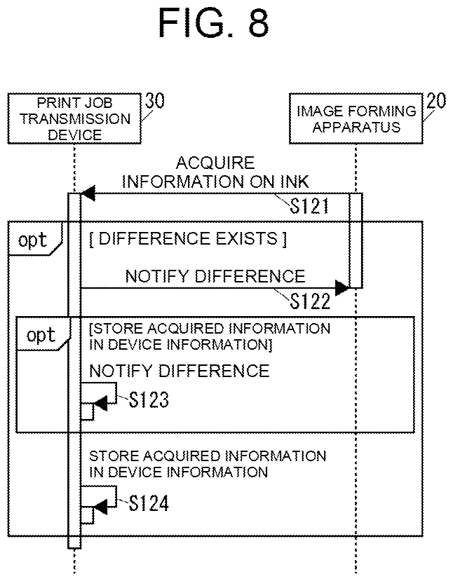

In the operation illustrated in FIG. 5, when an event that has occurred in the image forming apparatus 20 is notified by the image forming apparatus 20 in S121, the information acquirer 35b of the print job transmission device 30 acquires information on the ink in the image forming apparatus 20 from the image forming apparatus 20 regardless of the type of the event (S122). However, as illustrated in FIG. 7 or FIG. 8, the information acquirer 35b may acquire information on the ink in the image forming apparatus 20 from the image forming apparatus 20 only when a specific event occurs in the image forming apparatus 20.

FIG. 7 is a sequence diagram of an example of the operation of the image forming system 10 when an event occurs in the image forming apparatus 20, which is different from the example illustrated in FIG. 5.

The operation illustrated in FIG. 7 differs from the operation illustrated in FIG. 5 in that the controller 35 of the print job transmission device 30 executes the processing of S122 to S124 only when an event whose event importance level is an error is notified from the image forming apparatus 20 to the print job transmission device 30 in S121.

FIG. 8 is a sequence diagram of an example of the operation of the image forming system 10 when an event occurs in the image forming apparatus 20, which is different from the examples illustrated in FIGS. 5 and 7.

Unlike the operation illustrated in FIG. 5, the operation illustrated in FIG. 8 is performed by the controller 35 of the print job transmission device 30 only when an event identified by the event ID with which information indicating that it is an ink-related event is associated in the event ID list 34c, that is, an ink-related event is notified from the image forming apparatus 20 to the print job transmission device 30 in S121, the controller 35 of the print job transmission device 30 executes the processing of S122 to S124.

As illustrated in FIG. 7 or FIG. 8, in a case where a specific event is notified by the image forming apparatus 20 in S121, when the print job transmission device 30 acquires specific information from the image forming apparatus 20 (S122), the possibility of acquiring information from the image forming apparatus 20, that is less necessary for the print job transmission device 30 side, can be further reduced. As a result, the load on the image forming system 10 for acquiring information from the image forming apparatus 20 can be further reduced.

In a case where an event indicating that the level of a specific ink is less than or equal to a certain amount is notified from the image forming apparatus 20 in S121, when acquiring the ink level in the image forming apparatus 20 from the image forming apparatus 20 in S122, the print job transmission device 30 can make the user recognize that the event notified in S121 is correct, on the basis of the information acquired in S122. Similarly, in a case where an event indicating that the cassette of a specific ink is not set in the image forming apparatus 20 is notified from the image forming apparatus 20 in S121, when acquiring the availability of the ink in the image forming apparatus 20 from the image forming apparatus 20 in S122, the print job transmission device 30 can make the user recognize that the event notified in S121 is correct, on the basis of the information acquired in S122.

In this embodiment, a feature is described in which the print job transmission device 30 acquires information on the ink in the image forming apparatus 20 from the image forming apparatus 20. However, the same applies to a feature where the print job transmission device 30 acquires information other than the information on the ink in the image forming apparatus 20 from the image forming apparatus 20. For example, the same applies to a feature where the print job transmission device 30 acquires information on the recording medium in the image forming apparatus 20 from the image forming apparatus 20.

What is claimed is:

1. A print job transmission device comprising:
a print job transmitter to transmit a print job to an image forming apparatus;
an information acquirer to acquire information from the image forming apparatus,
wherein the information acquirer acquires specific information from the image forming apparatus when an event that has occurred in the image forming apparatus is notified by the image forming apparatus.

2. The print job transmission device according to claim 1, wherein the information acquirer acquires the specific information from the image forming apparatus when the event that is specific is notified by the image forming apparatus.

3. A computer-readable non-transitory recording medium storing a print job transmission program causing a computer to implement:
a print job transmitter to transmit a print job to an image forming apparatus;
an information acquirer to acquire information from the image forming apparatus,
wherein the information acquirer acquires specific information from the image forming apparatus when an event that has occurred in the image forming apparatus is notified by the image forming apparatus.
